(19) United States
(12) Patent Application Publication
(10) Pub. No.: US 2022/0372787 A1
(43) Pub. Date: Nov. 24, 2022

(54) LOCK WITH A PULL-OUT HANDLE

(71) Applicant: DAKEN S.P.A., Bari (IT)

(72) Inventors: Domenico LORUSSO, Altamura (Bari) (IT); Michele VENEZIA, Matera (IT); Luca CORRADO, Altamura (Bari) (IT)

(21) Appl. No.: 17/777,901

(22) PCT Filed: Nov. 19, 2020
(86) PCT No.: PCT/IB2020/060892

§ 371 Date: May 18, 2022

(30) Foreign Application Priority Data
Nov. 19, 2019 (IT) 102019000021624

(51) Int. Cl. E05B 5/02; E05B 5/00

(52) U.S. Cl. CPC E05B 5/003; E05B 5/006

(57) ABSTRACT

A lock is provided which has a handle, a body and a hook, mutually held together by a slidable pin. The handle is movable between a retracted position and an extracted position, the handle being configured to rotate with respect to the body.

### TECHNICAL FIELD

This invention relates, in general, to the sector of locks; in particular, the invention refers to a lock with a pull-out handle.

### SUMMARY OF INVENTION

Locks equipped with rotating or pull-out handles are known.

An example of a lock equipped with a handle extraction mechanism is known from the document U.S. Pat. No. 2,833,582 A1.

A lock according to this invention provides a handle, which is rotatably slidable within a body fixed to a support (for example, the access door to a load compartment of a commercial vehicle, the door of a piece of furniture or a wall unit, a door, etc.), in such a way that, once extracted, it is rotatable integrally with a hook which disengages a striker, with respect to which the support is kept in a fixed position when the lock is in a closed configuration.

To carry out these rotary translation movements, the aforesaid components of the lock (i.e. the handle, the body and the hook) are equipped with tubular portions, mutually concentric, in which slots are obtained wherein a pin is inserted, which binds the relative movement between such tubular portions.

Specifically, the tubular portion associated with the body comprises a circumferential slot, at least partially aligned with a hole passing through the tubular portion associated with the hook and with a slot extending at least partially in the axial direction along the tubular portion associated with the handle.

The pin, passing through the through-hole in the tubular part of the hook, is inserted slidably into the slots of the tubular portions associated with the other two elements.

In this way, the pin, sliding in the at least partially axial slot of the handle, guides said handle in the movement of extraction (both in the axial direction and, preferably, in the rotational direction); thus, when the handle is maximally extracted axially, the sliding of the pin inside the circumferential slot of the body guides the handle in rotation, integrally with the hook.

With such a configuration, it is also possible to provide a lock of a latch which, by engaging the hook, prevents its rotation (i.e., by keeping the lock in the closed configuration).

Expediently, when the handle is in the retracted position, the relative grip portion blocks access to the latch, so that it is necessary to extract the handle in order to disarm the latch, disengaging the hook which, in turn, may rotate integrally with the handle, releasing the support to which the lock may be secured.

Moreover, according to a further aspect of the invention, the lock comprises a handle release mechanism of the so-called “push-pull” type (the application of which is well known, for example, for opening and closing cabinets and doors, an application wherein they are typically associated with magnets), comprising a pair of telescopically extendable tubular portions and equipped with coupling portions adapted to engage each other when the handle is in the retracted position, and disengage when the handle is pushed toward the rear portion of the lock so as to hold the handle in the retracted position with respect to the body and push the handle in axial extraction with respect to this body, respectively.

The aforesaid and other objects and advantages are achieved by a lock having the features defined in the appended claims. Preferred embodiments of the invention are defined in the dependent claims.

### BRIEF DESCRIPTION OF THE DRAWINGS

The functional and structural features of some preferred embodiments of a lock according to the invention will now be described. Reference is made to the accompanying drawings, wherein:

FIG. 1 is a schematic perspective view of a lock, according to an embodiment of this invention;

FIG. 2 is an exploded perspective view of the lock in FIG. 1;

FIG. 3 is an exploded perspective view of a lock according to a further embodiment of this invention;

FIG. 4A to 4H are a series of perspective views, illustrating an operating sequence of the lock of FIG. 3, which show respectively a closing configuration of the lock (wherein the handle is in the retracted position, and the hook behind it is rotated into a position adapted to hold any support to which the lock is secured in the closed position), a series of passages of the handle up to an angularly intermediate position (rotated 90° with respect to the initial position of the handle), and a further angular excursion of 90° to cause the rotation and lowering of the hook (with consequent release of any support); and

FIG. 5A to 5F are a series of schematic views in longitudinal section, illustrating an operating sequence of the lock according to an embodiment of the invention, which show respectively a closed configuration of the lock (wherein the handle is in the retracted position), a step wherein the handle is pushed axially in the direction of the hook to disengage coupling elements of a so-called “push-pull”-type actuation mechanism, an axial stroke of the handle coming out of the body, the rotation of the same by 180° (whereof 90° runs integrally with the hook), the return of the handle into the body with an extra stroke to restore the locking condition of the actuation mechanism, and the return of the handle to a position axially corresponding to the retracted position.

### DETAILED DESCRIPTION

Before describing in detail a plurality of embodiments of the invention, it should be clarified that the invention is not limited in its application to the construction details and the configuration of the components presented in the following description or illustrated in the drawings. The invention is able to assume other embodiments and to be implemented or constructed in practice in different ways. It should also be understood that the phraseology and terminology have a descriptive purpose and should not be construed as limiting.

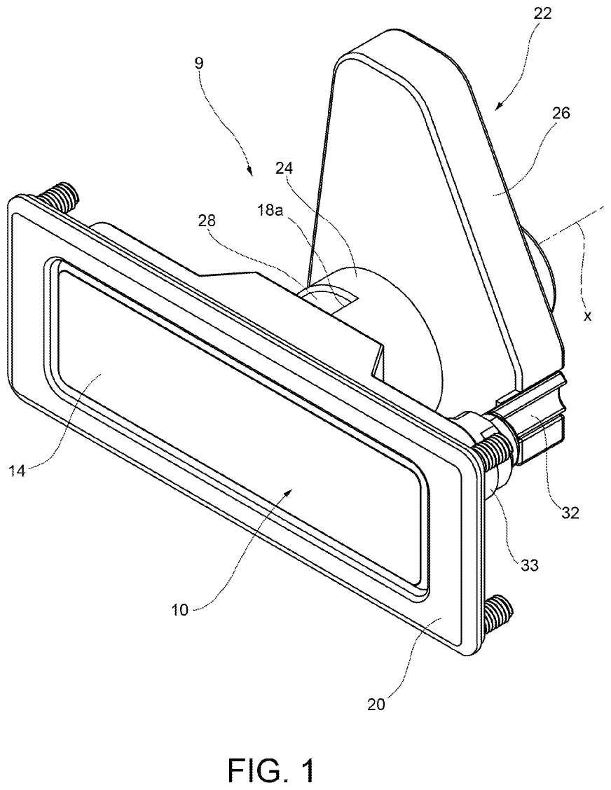

Referring by way of example to FIG. 1, a lock 9 comprises a handle 10, which includes a primary tubular portion 12, elongated in an axial direction.

The primary tubular portion 12 comprises a primary groove 12a, extending over at least part of an outer lateral surface of the primary tubular portion 12 along said axial direction.

The handle 10 further comprises a grip portion 14, integrally connected to a first end of the primary tubular portion 12 and elongated in a direction perpendicular to said axial direction. Said grip portion 14 is contoured in such a way as to allow a user to grip it, in order to manipulate the handle 10.

There is also a body 16, adapted to be fixed to a first external support and comprising a secondary tubular portion 18, elongated in said axial direction.

This secondary tubular portion 18 comprises a secondary groove 18a passing therethrough, extending circumferentially along at least part of the lateral surface of said secondary tubular portion 18. Preferably, the ends of the secondary groove 18a are circumferentially spaced 180° apart.

The secondary tubular portion 18 accommodates coaxially the primary tubular portion 12 of the handle 10, in a slidable and rotatable manner with respect to a main axis x parallel to said axial direction, the end of the handle 10 which carries the grip portion 14 protruding axially to the exterior of said secondary tubular portion 18.

The lock 9 further includes a hook 22, comprising a tertiary tubular portion 24, elongated in the axial direction and mounted coaxial to said primary and secondary tubular portions 12, 18.

This tertiary tubular portion 24 has a through-hole 24a, oriented along a radial direction, and the hook 22 further comprises a striker 26, placed at one end of the tertiary tubular portion 24 distal with respect to the grip portion 14 of the handle 10 and elongated in a direction perpendicular to said axial direction.

The striker 26 is rotatable integrally with the tertiary tubular portion 24 with respect to the body 16 about the main axis x and is adapted to abut against a second external support to prevent its movement with respect to said first external support.

There is also a pin 28, passing through the through-hole 24a of the tertiary tubular portion 24 and slidably accommodated in the axial and/or circumferential direction in the primary groove 12a and in the secondary groove 18a. In effect, the through-hole 24a, the primary groove 12a and the secondary groove 18a are in a condition of at least partial alignment, such that the pin 28 may simultaneously engage said through-hole 24a, said primary groove 12a and said secondary groove 18a.

The handle 10 is movable between a retracted position, wherein the primary tubular portion 12 is mostly accommodated in the secondary tubular portion 18 and the grip portion 14 is arranged in a first angular position, and an extracted position, wherein the primary tubular portion 12 is maximally protruding axially from the secondary tubular portion 18 and the grip portion 14 is arranged in a second angular position, rotated (expediently, by 180°) with respect to the first angular position.

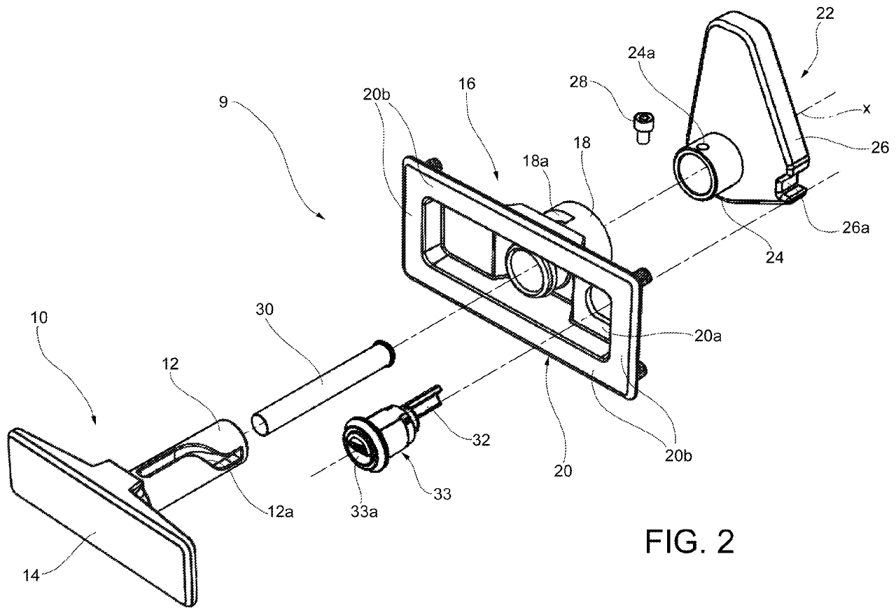

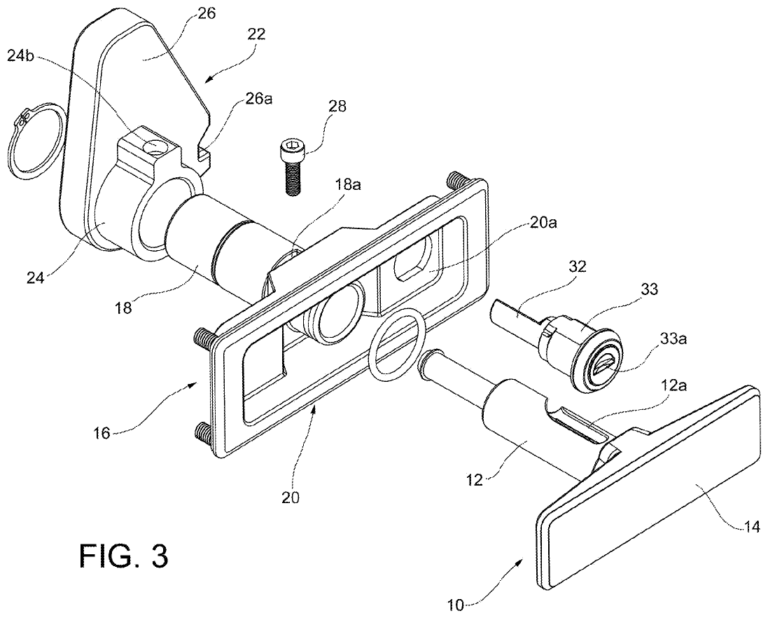

According to the configurations, the tertiary tubular portion 24 of the hook 22 may be in a radially external position with respect to the secondary tubular portion 18 of the body 16 (as, for example, in the embodiment illustrated in FIG. 3), or in a radially intermediate position between the secondary tubular portion 18 of the primary tubular portion 12 of the handle 10 (as, for example, in the embodiment illustrated in FIG. 2). Expediently, the primary tubular portion 12 of the handle 10 is radially accommodated inside the other two secondary and tertiary tubular portions 18, 24.

Expediently, the ends of the primary groove 12a are axially spaced by a length at least equal to the stroke of the handle 10 from the retracted position to the extracted position, so that the pin 28, in the condition of maximum axial extraction of the handle 10, abuts against the end of said primary groove 12a, distal with respect to the grip portion 14.

According to a preferred embodiment, the grip portion 14 is rotatable about the main axis x in a manner integral with the hook 22 between a median position, angularly intermediate between said retracted and extracted positions of the handle 10 (for example, at 90° with respect to the first angular position), and said extracted position.

This effect is expediently obtained by contouring the primary groove 12a so that it extends between two ends spaced axially and circumferentially along the outer lateral surface of the primary tubular portion 12. In this way, the sliding of the pin 28 inside the primary groove 12a, in the passage of the handle 10 from the retracted position to the median position, causes a rotation of the handle 10 about the main axis x.

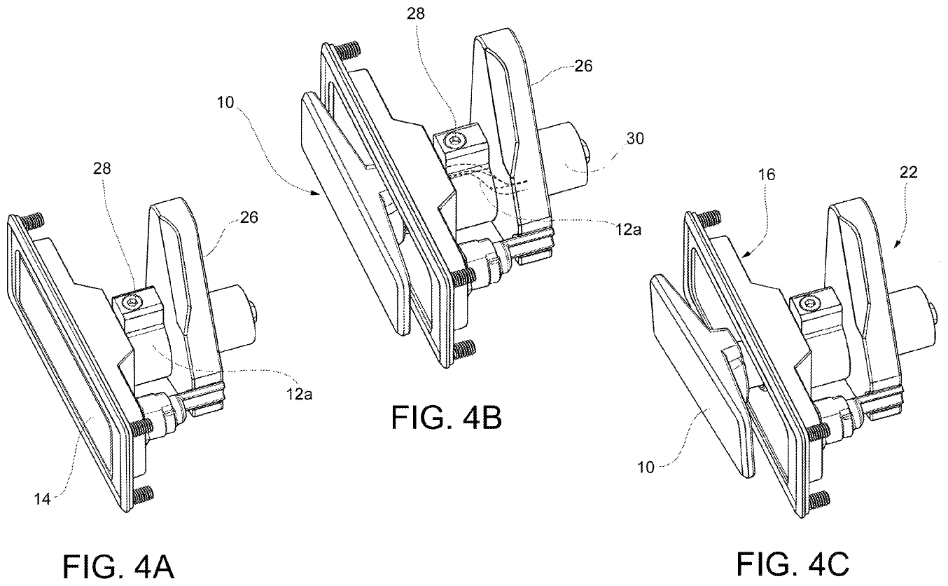

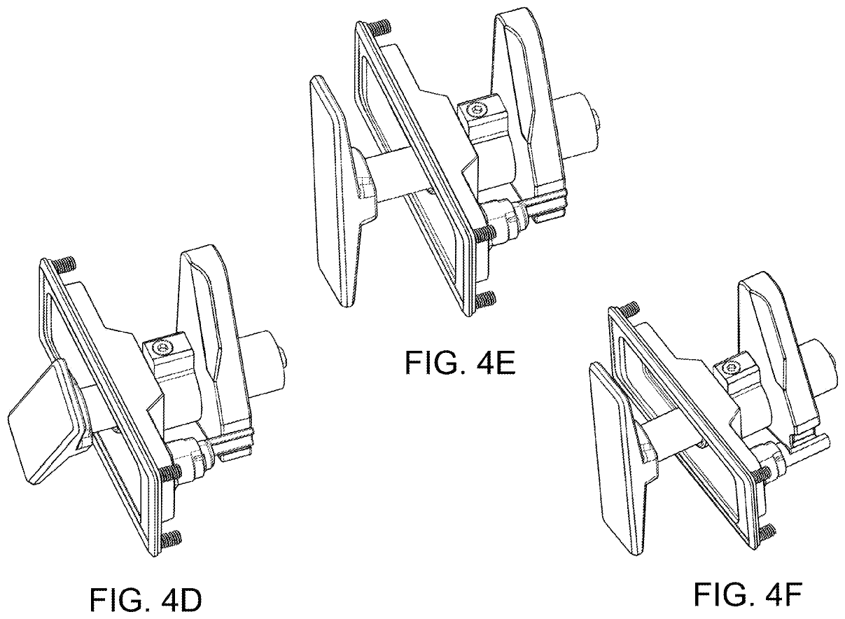

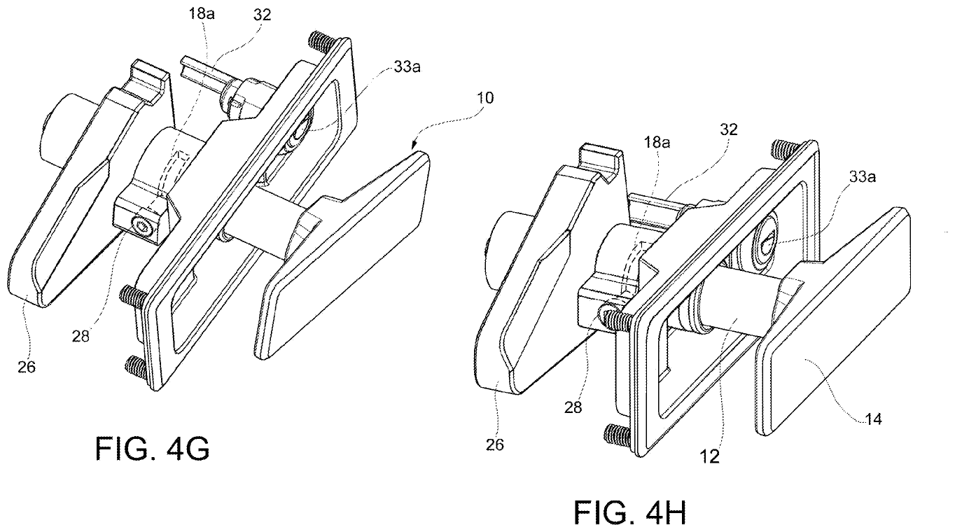

An operating sequence of the lock 9, in the transition from the retracted position to the extracted position of the handle 10, is shown by way of example in FIG. 4A to 4G, which will be described below merely for illustrative purposes to better clarify the operating principle of a lock according to an embodiment of this invention.

In particular, FIG. 4A shows the lock 9 with the handle 10 in the retracted position (the relative grip portion 14 being received in a tray or embedding portion 20 of the body 16, as described below).

Subsequently, the handle 10 is axially extracted from the body 16; during the stroke, the pin 28 slides within the primary groove 12a. In the illustrated example, this primary groove 12a has a pseudo-helical course, with a first substantially axial portion (inside of which the pin 28 slides to force the handle 10 to travel an axial stroke, as shown by way of example in FIG. 4B), and a second non-axial section, inside of which the pin 28 slides to force the handle 10 to rotate about the main axis x (as shown by way of example in FIG. 4B to 4E, the rotation being expediently 90° in a counterclockwise direction), until reaching the median position of the handle 10 (as shown by way of example in FIG. 4F).

In this median position, the handle 10 is made to rotate further (expediently, by a further 90° in a counterclockwise direction). In this configuration, the pin 28 abuts against the side of the primary groove 12a, whereby it is pulled to slide inside the secondary groove 18a (as illustrated by way of example in FIGS. 4G and 4H), causing the hook 22 also to rotate about the main axis x. This involves the rotation of the striker 26, and the relative passage from a condition of potential engagement with an external protuberance (to which the support of the lock 9 would be bound), to a condition of potential disengagement therefrom (so that the support of the lock 9 is made movable with respect to the protuberance). In the illustrated example, these conditions of potential engagement and disengagement of the hook 22 from the external protuberance are represented by a vertically raised or horizontally lowered position of the striker 26 respectively.

Expediently, once the extracted position has been reached, the handle 10 may be further retracted in an axial direction with respect to the body 16, until it abuts in a final position axially corresponding to the retracted position.

According to a preferred embodiment, the body 16 further comprises an embedding portion 20, integrally connected to a first end of the secondary tubular portion 18 (proximal to the grip portion 14) and elongated in a direction perpendicular to said axial direction, the embedding portion 20 of which has a box-like section which identifies a compartment adapted to receive at least partially the grip portion 14 of the handle 10.

Expediently, the compartment defined by the embedding portion 20 is delimited by a back wall 20a, extending on a plane parallel to the plane of rotation of the grip portion 14 between said first and second angular positions, and four side walls 20b, facing in pairs and projecting perpendicularly from the back wall 20a with respect to the axial direction.

Expediently, the lock 9 comprises a swivel pin 32, rotatably supported by the back wall 20a of the embedding portion 20 about an axis parallel to the main axis x, said swivel pin 32 protruding from the back wall 20a toward the striker 26 and being rotatable between an engagement position, wherein the swivel pin 32 engages the striker 26 and prevents a rotation of said striker 26 about the main axis x, and a disengagement position, wherein the swivel pin 32 avoids engaging the striker 26 and permits a rotation of said striker 26 around the main axis x integral with the handle 10.

Ideally, the swivel pin 32 is a substantially cylindrical or semi-cylindrical element, adapted to engage a corresponding seat 26a on the striker 26, whereby, when the swivel pin 32 is accommodated in said seat 26a, a rotation of said striker 26 about the main axis x is prevented.

According to a preferred embodiment, the swivel pin 32 may not be rotated when the handle 10 is in its retracted position, wherein the grip portion 14 is accommodated in the embedding portion 20.

Expediently, the lock 9 comprises a traditional cylinder for locks 33 operatively associated with the swivel pin 32 and adapted to rotate said swivel pin. This lock cylinder 33 includes an access compartment 33a, adapted to allow the insertion of a key for operating the lock cylinder 33 (in a manner well known to a person skilled in the art), this access compartment 33a facing the compartment defined by the bottom and side walls 20a, 20b of the embedding portion 20 (whereby, when the handle 10 is in the retracted position, the relative grip portion 14, by inserting itself into the embedding portion 20, closes the access compartment 33a, preventing the actuation of the cylinder 33, and the consequent rotation of the swivel pin 32).

Ideally, a resilient means (not shown) is provided which on the one hand engages the body 16 and/or the hook 22, and on the other the handle 10, this resilient means being capable of pushing the handle 10 from the retracted position toward the extracted position.

According to a preferred embodiment, the lock 9 comprises a release mechanism 30, coaxially accommodated in a radially internal position with respect to the primary, secondary and tertiary tubular portions 12, 18, 24, said mechanism comprising a radially internal cylindrical portion 30a, having an end fixed to the body 16 and/or to the hook 22, and a radially external cylindrical portion 30b, having one end fixed to the handle 10.

Such internal and external portions 30a, 30b are telescopically extendable from a compact configuration, wherein the handle 10 is in the retracted position, to an extended configuration, wherein the handle 10 is in the extracted position.

Expediently, the operating mechanism 30 is configured as a mechanism of the so-called “push-pull” or “push latch” or “push to open latch” type, wherein a pressure on the extendable element (in this case, the handle 10) toward a recessed position in the relative support (in this case, the body 16) produces a brief extra stroke of this extendable element, with consequent disengagement of the coupling elements which bind the telescopic components of the actuation mechanism 30 to each other. These telescopic components, released in this manner, then extend telescopically, pushing the extendable element toward an extracted position from the support.

An example of a functionally similar mechanism is known from the document US 2014001938 A1, which describes a system for locking and extracting a piston from a body by means of the engagement of resilient means and profiles in mutual coupling.

According to an embodiment, the radially internal and external portions 30a, 30b of the release mechanism 30 comprise respective coupling means 31a, 31b, capable of passing (when the handle 10, being in the retracted position, is pushed toward the hook 22) from a mutual coupling configuration, wherein said radially internal and external cylindrical portions 30a, 30b are held in the compact configuration against the thrust of the resilient means, to a decoupling configuration, wherein said radially internal and external cylindrical portions 30a, 30b are telescopically extendable under the thrust of said resilient means.

According to a preferred embodiment, the radially external cylindrical portion 30b comprises a hollow cylindrical sleeve, inside of which a cylindrical stem extends which carries, near its end (distal to the grip portion 14), the respective coupling means 31b (in the form, for example, of an externally threaded cylindrical portion). At the same time, the radially internal cylindrical portion 30a comprises a hollow cylindrical crown, fixed at one end to the body 16 and/or to the hook 22, and inserted in a radially intermediate position between the cylindrical sleeve and the stem of the radially external cylindrical portion 30b, in such a way that said cylindrical sleeve and stem are integrally slidable with respect to said hollow cylindrical crown. The hollow cylindrical crown includes respective coupling means 31a, configured, for example, in the form of a pair of internally threaded cylindrical portions.

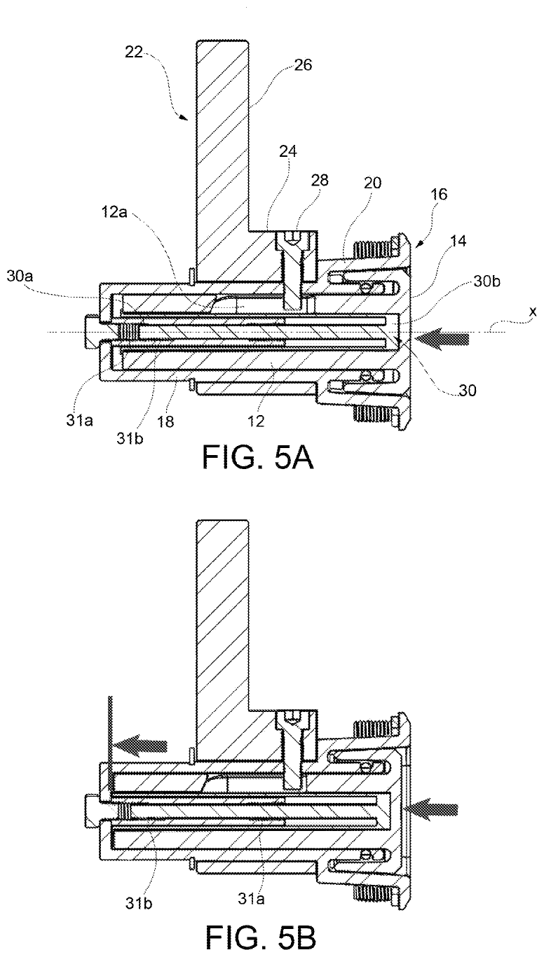

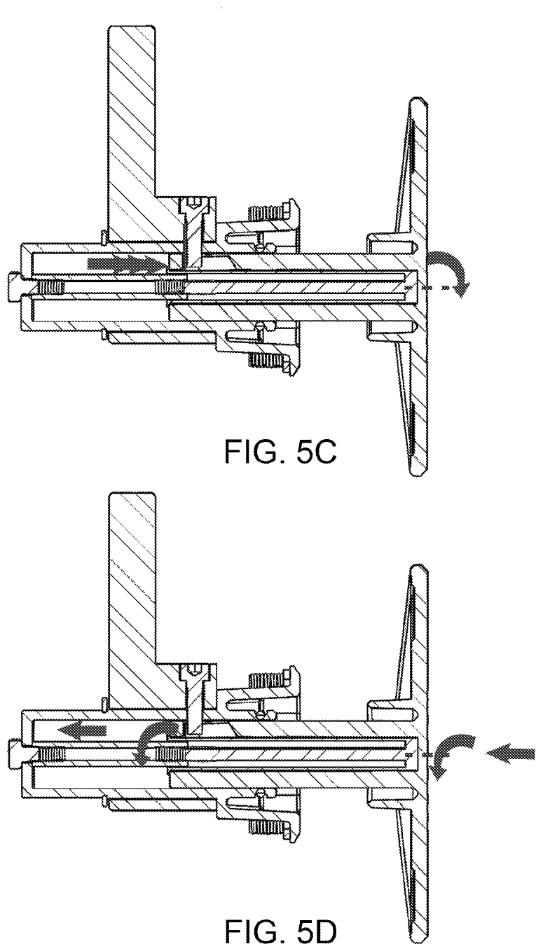

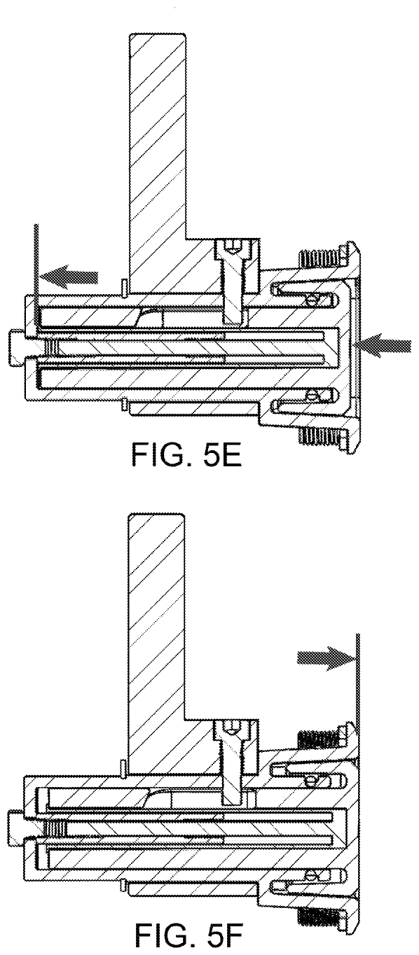

The coupling means 31a, 31b, associated with the two radially internal and external cylindrical portions 30a, 30b, are configured in such a manner that, when the handle 10 is in the retracted position, the coupling means 31b of the radially external cylindrical portion 30b engages the first coupling means 31a of the radially internal cylindrical portion 30a (distal with respect to the grip portion 14), preventing the radially external cylindrical portion 30b from sliding axially with respect to the radially external cylindrical portion 30b (as illustrated by way of example in FIG. 5A).

Such coupling means 31a, 31b are also arranged to disengage when the handle 10 (and, consequently, the radially external cylindrical portion 30b, which is integral therewith) retracts further inside the body 16 in response to a thrust exerted from the outside on the grip portion 14; this determines the telescopic extension of the radially external cylindrical portion 30b with respect to the radially internal cylindrical portion 30a (as illustrated by way of example in FIGS. 5B and 5C), expediently under the thrust of a resilient means, accommodated in the actuation mechanism 30 between the external sleeve, the stem and the cylindrical crown.

When the radially external cylindrical portion 30b is maximally extended with respect to the radially internal cylindrical portion 30a, and the handle 10 has been rotated around the main axis x to the extracted position (as illustrated by way of example in FIG. 5D), the handle 10 is further retractable (in response to a thrust exerted from the outside on the grip portion 14) in the body 16, to an end-stroke position, axially more rearward (with respect to the embedding portion 20) than the retracted position.

In this condition, the coupling means 31a, 31b are arranged to engage each other when the handle 10 returns to a position axially corresponding to the retracted position; this prevents the telescoping of the radially external cylindrical portion 30b with respect to the radially internal cylindrical portion 30a.

Throughout this description and in the claims, the terms and expressions indicating positions and orientations, such as “axial” or “radial,” refer to the main axis x.

Various aspects and embodiments of a lock according to the invention have been described. It is understood that each embodiment may be combined with any other embodiment. Furthermore, the invention is not limited to the described embodiments, but may be varied within the scope defined by the appended claims.

1. A lock, comprising:
a handle, comprising a primary tubular portion, elongated in an axial direction and comprising a primary groove extending over at least part of an outer lateral surface of the primary tubular portion along said axial direction, the handle further comprising a grip portion, integrally connected to a first end of the primary tubular portion and elongated in a direction perpendicular to said axial direction;
a body, configured to be fixed to a first support and comprising a secondary tubular portion, elongated in said axial direction and comprising a secondary through groove extending circumferentially along at least part of a lateral surface of said secondary tubular portion, said secondary tubular portion accommodating coaxially the primary tubular portion of the handle in a slidable and rotatable manner with respect to a main axis parallel to said axial direction;
a hook, comprising a tertiary tubular portion, elongated in the axial direction and mounted coaxial to said primary and secondary tubular portions, said tertiary tubular portion comprising a through-hole oriented along a radial direction, said hook further comprising a striker, placed at one end of the tertiary tubular portion, distal with respect to the grip portion of the handle and elongated in a direction perpendicular to said axial direction, said striker being rotatable integrally rotatable with the tertiary tubular portion about the main axis with respect to the body and being configured to abut against a second support to prevent movement thereof of the second support with respect to said first support; and
a pin, passing through the through-hole of the tertiary tubular portion and slidably accommodated in the axial direction and/or circumferential direction in the primary groove and the secondary through groove;
said handle being movable between a retracted position, in which the primary tubular portion is maximally accommodated in the secondary tubular portion and the grip portion is arranged in a first angular position, and an extracted position, in which the primary tubular portion is maximally protruding axially from the secondary tubular portion and the grip portion is arranged in a second angular position, rotated with respect to the first angular position;
said lock further comprising a release mechanism, coaxially accommodated in a radially internal position with respect to the primary, secondary and tertiary tubular portions, said release mechanism comprising a radially internal cylindrical portion, having one end fixed to the hook, and a radially external cylindrical portion, having one end fixed to the handle said radially internal and external cylindrical portions being telescopically extendable from a compact configuration, in which the handle is in the retracted position, to an extended configuration, in which the handle is in the extracted position,
wherein the radially internal and external cylindrical portions of the release mechanism comprise respective coupling means configured to pass from a mutual coupling configuration, in which said radially internal and external cylindrical portions are held in the compact configuration against a thrust of a resilient means, to a decoupling configuration, in which said radially internal and external cylindrical portions are telescopically extendable under the thrust of said resilient means, said coupling means being configured to disengage each other when the handle, being in the retracted position, is pushed toward the hook.

2. The lock of claim 1, wherein the radially external cylindrical portion comprises a hollow cylindrical sleeve, a cylindrical stem extending in said hollow cylindrical sleeve and carrying, in proximity to its end, distal with respect to the grip portion, the respective coupling means, and wherein the radially internal cylindrical portion comprises a hollow cylindrical crown, fixed at one of the ends thereof end to the body and/or to the hook, said hollow cylindrical crown being inserted in a radially intermediate position between the hollow cylindrical sleeve and the cylindrical stem of the radially external cylindrical portion, so that said hollow cylindrical sleeve and cylindrical stem are integrally slidable with respect to the hollow cylindrical crown, the hollow cylindrical crown including respective coupling means, shaped as a pair of internally threaded cylindrical portions, the coupling means, associated with the radially internal and external cylindrical portions being configured so that when the handle is in the retracted position, the coupling means of the radially external cylindrical portion engages the coupling means of the radially internal cylindrical portion, preventing the radially external cylindrical portion from sliding axially with respect to the radially external cylindrical portion.

3. The lock of claim 1, wherein the grip portion is rotatable around the main axis in an integral manner with the hook between a median position, angularly intermediate between said retracted and extracted positions of the handle, and said extracted position.

4. The lock of claim 3, wherein the primary groove is extended between two ends axially and circumferentially spaced along the outer lateral surface of the primary tubular portion, so that sliding of the pin within said primary groove in a passage of said handle from the retracted position to the median position causes rotation of the handle about the main axis.

5. The lock of claim 1, wherein the body further comprises an embedding portion integrally connected to a first end of the secondary tubular portion and elongated in a direction perpendicular to said axial direction, said embedding portion comprising a box section that defines a compartment configured to accommodate the grip portion of the handle, said compartment being delimited by a back wall, extending on a plane parallel to a plane of rotation of the grip portion between said first and second angular positions, and four side walls, facing each other in pairs and protruding perpendicularly from the back wall WO with respect to the axial direction.

6. The lock of claim 5, comprising a swivel pin, rotatably supported by the back wall of the embedding portion about an axis parallel to the main axis, said swivel pin protruding from the back wall toward the striker and being rotatable between an engagement position, in which the swivel pin engages the striker and prevents rotation of said striker about the main axis, and a disengagement position, in which the swivel pin avoids engaging the striker and rotation of said striker about the main axis integrally with the handle is allowed.

7. The lock of claim 6, wherein the swivel pin is not rotatable when the handle is in the retracted position, and wherein the grip portion is accommodated in the embedding portion.

8. The lock of claim 7, comprising a lock cylinder operatively associated with the swivel pin and configured to rotate said swivel pin, said lock cylinder including an access compartment configured to allow insertion of a key to operate the lock cylinder, said access compartment facing the compartment delimited by the back wall and four side walls of the embedding portion.

9. Lock (9) A lock, comprising:
a handle, comprising a primary tubular portion, elongated in an axial direction and comprising a primary groove extending over at least part of an outer lateral surface of the primary tubular portion along said axial direction, the handle further comprising a grip portion, integrally connected to a first end of the primary tubular portion and elongated in a direction perpendicular to said axial direction;
a body, configured to be fixed to a first support and comprising a secondary tubular portion, elongated in said axial direction and comprising a secondary through groove, circumferentially extending along at least part of a lateral surface of said secondary tubular portion, said secondary tubular portion accommodating coaxially the primary tubular portion of the handle in a slidable or rotatable manner with respect to a main axis parallel to said axial direction;
a hook, comprising a tertiary tubular portion, elongated in the axial direction and mounted coaxial to said primary and secondary tubular portions, said tertiary tubular portion comprising a through-hole oriented along a radial direction, said hook further comprising a striker, placed at one end of the tertiary tubular portion, distal with respect to the grip portion of the handle and elongated in a direction perpendicular to said axial direction, said striker being integrally rotatable with the tertiary tubular portion about the main axis with respect to the body and being configured to abut against a second support to prevent movement of the second support with respect to said first support; and
a pin, passing through the through-hole of the tertiary tubular portion and slidably accommodated in the axial direction and/or circumferential direction in the primary groove and the secondary through groove;
said handle being movable between a retracted position, in which the primary tubular portion is maximally accommodated in the secondary tubular portion and the grip portion is arranged in a first angular position, and an extracted position, in which the primary tubular portion is maximally protruding axially from the secondary tubular portion and the grip portion is arranged in a second angular position, rotated with respect to the first angular position,
wherein the body further comprises an embedding portion integrally connected to a first end of the secondary tubular portion and elongated in a direction perpendicular to said axial direction, said embedding portion comprising a box section that defines a compartment configured to accommodate the grip portion of the handle, said compartment being delimited by a back wall, extending on a plane parallel to a plane of rotation of the grip portion between said first and second angular positions, and four side walls, facing in pairs and protruding perpendicularly from the back wall with respect to the axial direction;
the lock further comprising a swivel pin, rotatably supported by the back wall of the embedding portion about an axis parallel to the main axis, said swivel pin protruding from the back wall toward the striker and being rotatable between an engagement position, in which the swivel pin engages the striker and prevents rotation of said striker about the main axis, and a disengagement position, in which the swivel pin avoids engaging the striker and rotation of said striker about the main axis integrally with the handle is allowed.

10. The lock of claim 9, wherein the swivel pin is not rotatable when the handle is in the retracted position, and wherein the grip portion is accommodated in the embedding portion.

11. The lock of claim 10, comprising a lock cylinder operatively associated with the swivel pin and configured to rotate said swivel pin, said lock cylinder including an access compartment configured to allow insertion of a key to operate the lock cylinder, said access compartment facing the compartment defined by the back wall and four side walls of the embedding portion.

12. The lock of claim 9, wherein the grip portion is rotatable about the main axis integrally with the hook between a median position, angularly intermediate between said retracted and extracted positions of the handle, and said extracted position.

13. The lock of claim 12, wherein the primary groove extends between two ends axially and circumferentially spaced along the outer lateral surface of the primary tubular portion, so that sliding of the pin inside said primary groove in a passage of the handle from the retracted position to the median position causes rotation of the handle about the main axis.

14. The lock of claim 9, comprising a release mechanism, coaxially accommodated in a radially internal position with respect to the primary, secondary and tertiary tubular portions, said release mechanism comprising a radially internal cylindrical portion, having end attached to the hook, and a radially external cylindrical portion, having one end attached to the handle, said radially internal and external cylindrical portions being telescopically extendable from a compact configuration, in which the handle is in the retracted position, to an extended configuration, in which the handle is in the extracted position.

15. The lock of claim 14, wherein the radially internal and external cylindrical portions of the release mechanism comprise respective coupling means configured to pass from a mutual coupling configuration, in which said radially internal and external cylindrical portions are held in the compact configuration against a thrust of a resilient means, to a decoupling configuration, in which said radially internal and external cylindrical portions are telescopically extendable under the thrust of said resilient means, said coupling means being configured to disengage each other when the handle, in the retracted position, is pushed toward the hook.
